(19) United States
(12) Patent Application Publication
(10) Pub. No.: US 2011/0132023 A1
(43) Pub. Date: Jun. 9, 2011

(54) Outer case of refrigerator and refrigerator having the same and manufacturing method thereof

(75) Inventors: Jin Ha Hwang, Gwangsan-gu (KR); Jung Geun Lee, Goyang-si (KR)

(73) Assignee: SAMSUNG ELECTRONICS CO., LTD, Suwon-si (KR)

(21) Appl. No.: 12/926,527

(22) Filed: Nov. 23, 2010

(30) Foreign Application Priority Data
Dec. 3, 2009 (KR) 10-2009-119065

(51) Int. Cl. F25D 23/02; F25D 11/00; B21J 7/02; B23P 17/00

(52) U.S. Cl. 62/449; 62/440; 72/76; 29/530

(57) ABSTRACT

An outer case of a refrigerator to conceal surface corrugation thereof and a refrigerator having the same and a manufacturing method thereof. The outer case is printed on a surface thereof with patterns, and surface indented portions constitute a part of the patterns. The iron outer case undergoes surface deformation due to a foamed material charged inside thereof. The surface indented portions formed at several positions of the surface of the outer case serve not only to prevent a user from recognizing the surface deformation, but also to conceal the surface deformation. The surface indented portions also provide the surface of the outer case with an aesthetically pleasing exterior appearance thus achieving decoration effects.

### CROSS-REFERENCE TO RELATED APPLICATIONS

This application claims the benefit of Korean Patent Application No. 2009-0119065, filed on Dec. 3, 2009 in the Korean Intellectual Property Office, the disclosure of which is incorporated herein by reference.

### BACKGROUND

1. Field

Embodiments relate to an outer case of a refrigerator to conceal surface deformation thereof and a refrigerator having the same and a manufacturing method thereof.

2. Description of the Related Art

A refrigerator is an apparatus to keep food fresh for long periods of time by supplying cold air, produced by a refrigeration cycle, into a storage compartment.

A general refrigerator includes a body in which a plurality of storage compartments is defined, and a plurality of doors to open or close the plurality of storage compartments.

The body includes an outer case defining an exterior appearance of the body, and an inner case defining the storage compartments. A foam material is introduced into and is foamed in a space between the outer case and the inner case to produce a thermal insulating foamed material.

However, if the foamed material undergoes shrinkage during hardening thereof, this may cause surface deformation, such as corrugation, of the outer case.

### SUMMARY

Therefore, it is an aspect to provide an outer case of a refrigerator to conceal surface deformation thereof and a refrigerator having the same and a manufacturing method thereof.

It is another aspect to provide an aesthetically pleasing outer case of a refrigerator and a refrigerator having the same and a manufacturing method thereof.

Additional aspects will be set forth in part in the description which follows and, in part, will be apparent from the description, or may be learned by practice of the invention.

In accordance with one aspect, a refrigerator includes a body, and an outer case defining an exterior appearance of the body, wherein the outer case includes a pattern to provide a surface of the outer case with an aesthetically pleasing exterior appearance, and at least one surface indented portion constituting at least a part of the pattern and having indentations formed at a surface thereof.

The pattern may include a flower pattern in the form of a flower, and the at least one surface indented portion may constitute a part of the flower pattern.

A color to represent the pattern may be applied to the at least one surface indented portion.

The at least one surface indented portion may be integrally formed with the outer case.

The outer case may be made from an iron plate.

The at least one surface indented portion may be formed by a press process using a press die.

In accordance with another aspect, an outer case of a refrigerator defining an exterior appearance of the refrigerator includes a pattern provided at a surface of the outer case to achieve an aesthetically pleasing exterior appearance, and at least one optical illusion causing portion constituting at least a part of the pattern and having indentations formed at a surface thereof to conceal surface deformation caused by a foamed material charged inside the outer case.

The pattern may include a flower pattern in the form of a flower, and the at least one optical illusion causing portion may constitute a part of the flower pattern.

A color to represent the pattern may be applied to the at least one optical illusion causing portion.

The at least one optical illusion causing portion may be integrally formed with the outer case.

The outer case may be made from an iron plate.

In accordance with another aspect, a manufacturing method of a refrigerator comprising a body, and an outer case defining an exterior appearance of the body, includes preparing a press die used to form at least one surface indented portion in a surface of the outer case, pressing a case material using the press die to integrally form the at least one surface indented portion with the outer case, and printing a pattern, at least a part of which is constituted by the surface indented portion, on the outer case.

The manufacturing method may further include foaming a foam material charged between the outer case having passed through the printing of the pattern and an inner case defining a wall of the storage compartment.

The case material may be an iron plate.

In accordance with another aspect, a manufacturing method of an outer case defining an exterior appearance of a refrigerator, includes preparing a press die used to form at least one surface indented portion in a surface of the outer case, pressing a case material using the press die to integrally form the at least one surface indented portion with the outer case, and printing a pattern, at least a part of which is constituted by the surface indented portion, on the outer case.

In accordance with another aspect, a refrigerator includes a body, and an outer case defining an exterior appearance of the body, wherein the outer case includes a pattern to provide a surface of the outer case with an aesthetically pleasing exterior appearance, and the pattern includes a surface indented portion formed by a press process.

In accordance with a further aspect, a refrigerator includes a body in which a storage compartment is defined, a door to open or close the storage compartment, and the door includes a pattern to provide a surface of the outer case with an aesthetically pleasing exterior appearance, and at least one surface indented portion constituting at least a part of the pattern and having indentations formed at a surface thereof.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of a Kimchi refrigerator according to an embodiment;

FIG. 2 is a sectional view taken along line I-I of FIG. 1;

FIG. 3 is a front view of FIG. 1;

FIG. 4 is a sectional view taken along line II-II of FIG. 1; and

FIG. 5 is a block diagram illustrating formation of a body of the Kimchi refrigerator.

### DETAILED DESCRIPTION

Reference will now be made in detail to the embodiments, examples of which are illustrated in the accompanying drawings, wherein like reference numerals refer to like elements throughout.

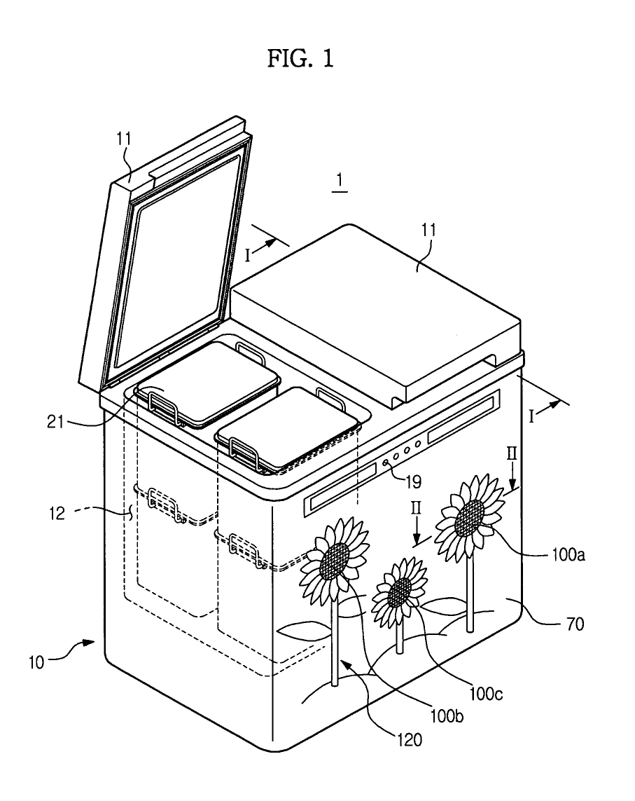

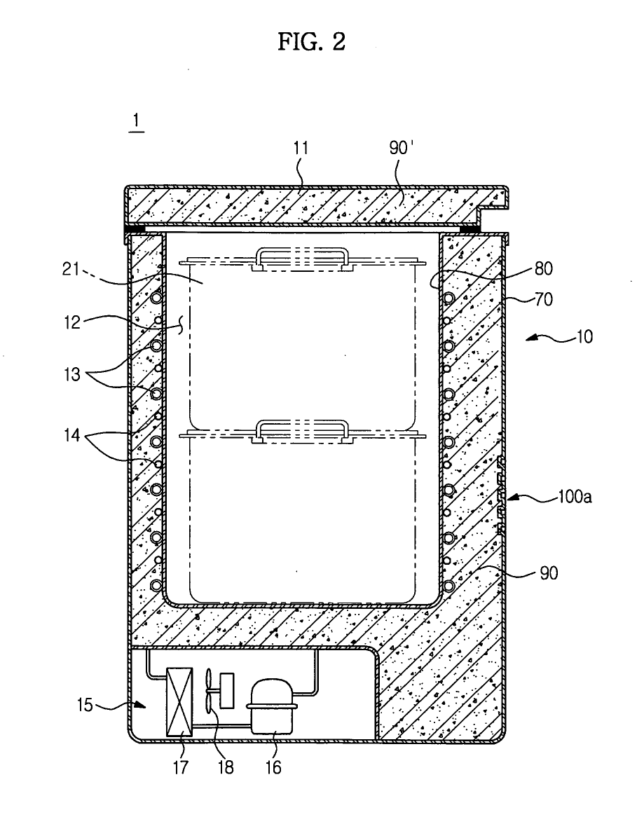

FIG. 1 is a perspective view of a Kimchi refrigerator according to an embodiment, and FIG. 2 is a sectional view taken along line I-I of FIG. 1.

As illustrated in FIGS. 1 and 2, the Kimchi refrigerator 1 according to the embodiment includes a storage compartment 12 defined in a body 10 to have an open upper side, a door 11 hingedly coupled to an upper end of the body 10 to open or close the storage compartment 12, and an input unit 19 provided at an upper portion of a front surface of the body 10. A storage container 21, in which food is stored, is accommodated in the storage compartment 12.

The body 10 includes an outer case 70 defining an exterior appearance of the body 10, and an inner case 80 defining the storage compartment 12 therein. A thermal insulating foamed material 90 is filled in a space between the outer case 70 and the inner case 80. The foamed material 90 is formed by foaming a urethane solution. A thermal insulating foamed material 90′ is filled in a inner space of door 11. The foamed material 90′ is formed by foaming a urethane solution.

The outer case 70 is made from an iron plate. The outer case 70 is provided at a surface thereof with patterns 120 and surface indented portions 100a, 100b and 100c. This will be described in detail hereinafter.

An electric machine room 15 is provided below the storage compartment 12 and is separated from the storage compartment 12 by a partition. The electric machine room 15 accommodates cooling devices.

An evaporator 13 to perform heat-exchange spirally surrounds an outer periphery of the storage compartment 12, and a heater 14 for ripening of Kimchi is arranged between respective turns of the evaporator 13.

In addition, a compressor 16 to compress a refrigerant, a condenser 17 to condense the compressed refrigerant having passed through the compressor 16, and a blowing fan 18 arranged near the condenser 17 to forcibly blow air toward the condenser 17 are accommodated in the electric machine room 15.

Now, the outer case 70 and the patterns 120 and surface indented portions 100a, 100b and 100c of the outer case 70 will be described in detail.

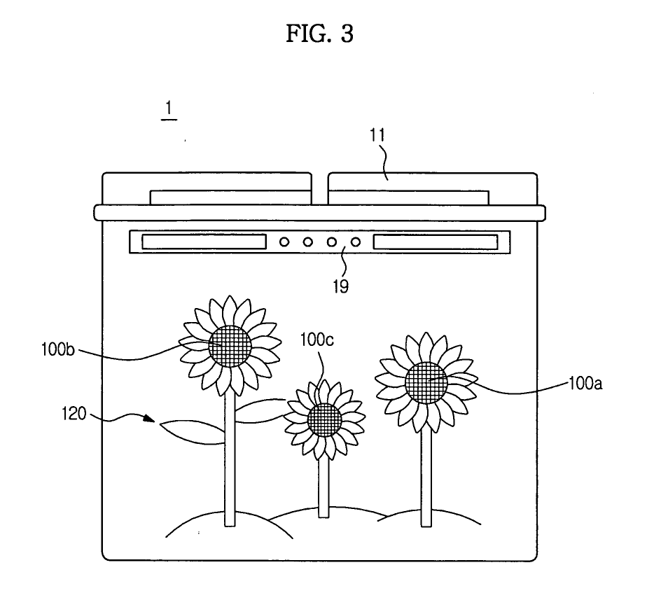

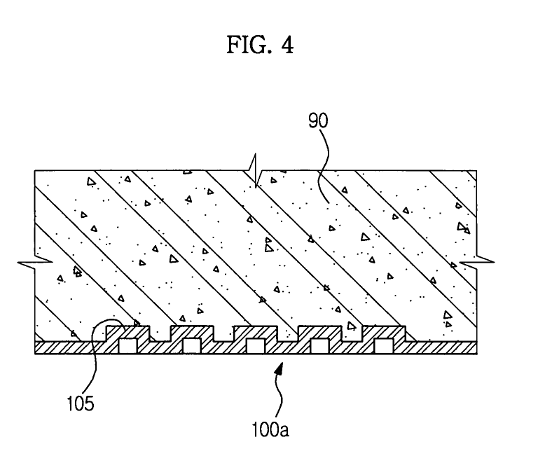

FIG. 3 is a front view of FIG. 1, and FIG. 4 is a sectional view taken along line II-II of FIG. 1.

As illustrated in FIGS. 1 to 4, the patterns 120 are provided at the surface of the outer case 70 to realize an aesthetically pleasing surface.

The patterns 120 are orderly arrangements of dots, lines and planes, and are represented as figures on the surface of the outer case 70.

In the embodiment, the patterns 120 have flower figures. Of course, various other figures of animals, plants and things may be adopted.

The patterns 120 are printed on the surface of the outer case 70. And the patterns 120 can be printed on the surface of the door 11.

The outer case 70 is also provided at the surface thereof with one or more surface indented portions 100a, 100b and 100c having indentations 105. And the door 11 can be provided at the surface thereof with one or more surface indented portions 100a, 100b, 100c having indentations 105.

Each surface indented portion 100a, 100b or 100c constitutes at least a part of the figure of the corresponding pattern 120. Specifically, in the embodiment, as illustrated in the drawing, the surface indented portions 100a, 100b and 100c constitute central portions of the flower figures represented by the patterns 120, and the remaining portions of the patterns 120, i.e. petals and stems of the flower figures, are printed portions. Alternatively, the surface indented portions 100a, 100b and 100c may constitute the entirety of the patterns 120. In this case, the patterns 120 including even the petals and stems of the flower figures may have a convex and concave texture.

The surface indented portions 100a, 100b and 100c may be colored according to the figures of the patterns 120. For example, to represent sunflowers as illustrated in the drawing, the surface indented portions 100a, 100b and 100c constituting the central portions of the flower figures may be colored with the same color, and the petals and stems of the remaining portions of the patterns 120 may be colored with yellow and green colors.

When the surface indented portions 100a, 100b and 100c are arranged at several positions on the surface of the outer case 70, it may be possible to conceal surface corrugation and swelling of the outer case 70.

Specifically, the foamed material 90 filled between the outer case 70 and the inner case 80 is formed by sequentially performing foaming and hardening of a urethane solution. The foamed material 90 undergoes shrinkage during hardening and consequently, shrinkage of the foamed material 90 causes surface corrugation and swelling of the iron outer case 70.

In the present embodiment adopting the surface indented portions 100a, 100b and 100c formed at several positions of the surface of the outer case 70, however, the indentations 105 of the surface indented portions 100a, 100b and 100c may prevent a user from recognizing surface corrugation due to shrinkage of the foamed material 90. In other words, the indentations 105 of the surface indented portions 100a, 100b and 100c may conceal surface corrugation and swelling. In addition, the surface indented portions 100a, 100b and 100c may act as optical illusion causing portions thus preventing the user from recognizing surface deformation, such as corrugation and swelling.

The surface indented portions 100a, 100b and 100c also indirectly serve as reinforcement structures to prevent surface corrugation and swelling.

Moreover, the surface indented portions 100a, 100b and 100c provide the user with unique surface texture, improving sensitivity and achieving decorative effects.

Hereinafter, formation of the surface indented portions 100a, 100b and 100c will be described.

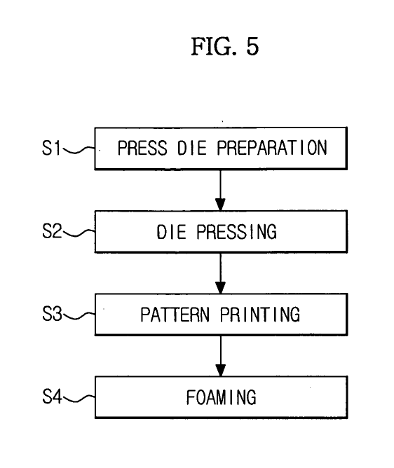

FIG. 5 is a block diagram illustrating formation of the body of the Kimchi refrigerator.

As illustrated in FIG. 5, the surface indented portions 100a, 100b and 100c of the outer case 70 are formed by a press process using a press die. To perform the press process, a press die to form the surface indented portions 100a, 100b and 100c in the surface of the outer case 70 is prepared (press die preparation S1).

Next, an iron plate as a case material is pressed using the press die to integrally form the surface indented portions 100a, 100b and 100c in the outer case 70 (die pressing S2).

Thereafter, the patterns 120 are printed on the outer case 70, on which the surface indented portions 100a, 100b and 100c have been formed, to achieve an aesthetically pleasing exterior appearance (pattern printing S3). In this case, the surface indented portions 100a, 100b and 100c may constitute at least a part of the patterns 120 or may constitute the entirety of the patterns 120.

A foam material is charged into and is foamed in a space between the outer case 70 that has passed through the pattern printing and the inner case 80 that defines the wall of the storage compartment 12, to form the thermal insulating foamed material 90 (foaming S4).

As described above, a manufacturing method of the outer case 70 of the Kimchi refrigerator 1 according to the embodiment includes the press die preparation S1, die pressing S2, pattern printing S3 and foaming S4. The outer case 70 manufactured via these operations may arouse optical illusion to conceal surface deformation owing to the surface indented portions 100a, 100b and 100c formed at several positions of the outer case 70. As such, the surface indented portions 100a, 100b and 100c also serve as optical illusion causing portions.

Although the above embodiment describes the Kimchi refrigerator 1 that is mainly used to store Kimchi by way of example, of course, the configuration of the surface indented portions 100a, 100b and 100c may be applied to other types of refrigerators. In particular, the configuration of the surface indented portions may be usefully applied when a foam solution is foamed inside an iron outer case.

As apparent from the above description, in an outer case of a refrigerator and a refrigerator having the same and a manufacturing method thereof according to an embodiment, surface indented portions are formed in a surface of the outer case to cause optical illusion thus concealing surface deformation of the outer case that may be caused after foaming of an insulating material.

Further, the surface indented portions may constitute a part of decorative patterns formed on the outer case, resulting in an aesthetically pleasing exterior appearance.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
a body; and
an outer case defining an exterior appearance of the body,
wherein the outer case includes a pattern to provide a surface of the outer case with an aesthetically pleasing exterior appearance, and at least one surface indented portion constituting at least a part of the pattern and having indentations formed at a surface thereof.

2. The refrigerator according to claim 1, wherein:
the pattern includes a flower pattern in the form of a flower; and
the at least one surface indented portion constitutes a part of the flower pattern.

3. The refrigerator according to claim 1, wherein a color to represent the pattern is applied to the at least one surface indented portion.

4. The refrigerator according to claim 1, wherein the at least one surface indented portion is integrally formed with the outer case.

5. The refrigerator according to claim 1, wherein the outer case is made from an iron plate.

6. The refrigerator according to claim 1, wherein the at least one surface indented portion is formed by a press process using a press die.

7. An outer case of a refrigerator defining an exterior appearance of the refrigerator comprising:
a pattern provided at a surface of the outer case to achieve an aesthetically pleasing exterior appearance; and
at least one optical illusion causing portion constituting at least a part of the pattern and having indentations formed at a surface thereof to conceal surface deformation caused by a foamed material charged inside the outer case.

8. The outer case according to claim 7, wherein:
the pattern includes a flower pattern in the form of a flower; and
the at least one optical illusion causing portion constitutes a part of the flower pattern.

9. The outer case according to claim 7, wherein a color to represent the pattern is applied to the at least one optical illusion causing portion.

10. The outer case according to claim 7, wherein the at least one optical illusion causing portion is integrally formed with the outer case.

11. The outer case according to claim 7, wherein the outer case is made from an iron plate.

12. A manufacturing method of a refrigerator comprising a body, and an outer case defining an exterior appearance of the body, the method comprising:
preparing a press die used to form at least one surface indented portion in a surface of the outer case;
pressing a case material using the press die to integrally form the at least one surface indented portion with the outer case; and
printing a pattern, at least a part of which is constituted by the surface indented portion, on the outer case.

13. The manufacturing method according to claim 12, further comprising foaming a foam material charged between the outer case having passed through the printing of the pattern and an inner case defining a wall of the storage compartment.

14. The manufacturing method according to claim 12, wherein the case material is an iron plate.

15. A manufacturing method of an outer case defining an exterior appearance of a refrigerator, the method comprising:
preparing a press die used to form at least one surface indented portion in a surface of the outer case;
pressing a case material using the press die to integrally form the at least one surface indented portion with the outer case; and
printing a pattern, at least a part of which is constituted by the surface indented portion, on the outer case.

16. A refrigerator comprising a body, and an outer case defining an exterior appearance of the body,
wherein the outer case includes a pattern to provide a surface of the outer case with an aesthetically pleasing exterior appearance, and
wherein the pattern includes a surface indented portion formed by a press process.

17. The refrigerator according to claim 16, wherein the pattern is an arrangement of two or more of shapes selected from the group consisting of dots, lines and planes.

18. A refrigerator comprising:
a body in which a storage compartment is defined;
a door to open or close the storage compartment; and
wherein the door includes a pattern to provide a surface of the outer case with an aesthetically pleasing exterior appearance, and at least one surface indented portion constituting at least a part of the pattern and having indentations formed at a surface thereof.
